(19) United States
(12) Patent Application Publication
(10) Pub. No.: US 2021/0402514 A1
(43) Pub. Date: Dec. 30, 2021

(54) WORKPIECE PROCESSING METHOD

(71) Applicant: DISCO CORPORATION, Tokyo (JP)

(72) Inventor: Asuka YAU, Tokyo (JP)

(21) Appl. No.: 17/337,520

(22) Filed: Jun. 3, 2021

(30) Foreign Application Priority Data
Jun. 26, 2020 (JP) 2020-110801

(51) Int. Cl. B23K 26/06; B23K 26/38

(52) U.S. Cl. CPC B23K 26/0648; B23K 26/38

(57) ABSTRACT

A workpiece processing method includes a first processing step of performing processing feeding with a focal point of a condenser lens positioned in the inside of a workpiece spaced from a front surface of a peripheral marginal area of the workpiece and processing the inside of the peripheral marginal area at a light concentrating point of a laser beam refracted by the front surface of the peripheral marginal area, and a second processing step of performing processing feeding with the focal point of the condenser lens positioned in the inside of the workpiece spaced from a front surface of a device area and processing the inside of the device area at the light concentrating point of the laser beam refracted by the front surface of the device area. In the first processing step, the focal point of the condenser lens is positioned outside the device area, and in the second processing step, the light concentrating point of the laser beam is formed outside the peripheral marginal area.

### BACKGROUND OF THE INVENTION

### Field of the Invention

The present invention relates to a workpiece processing method.

### Description of the Related Art

A semiconductor wafer or an optical device wafer on which a gallium nitride based compound semiconductor or the like is stacked is partitioned into a plurality of regions by streets, also referred to as division lines, arranged in a grid pattern on a front surface, and respective devices are formed in the partitioned regions. The wafer is cut along the streets, to divide the regions formed with the circuits, thereby manufacturing individual chips.

In recent years, as a method for dividing a workpiece such as the wafer described above, a laser processing method of applying a laser beam having a transmission wavelength to the workpiece with a light concentrating point set in the inside of the regions to be divided has been tried. The dividing method using this processing method includes applying the laser beam having a transmission wavelength to the workpiece, with the light concentrating point set in the inside from one surface side of the workpiece, to continuously form modified layers along the streets in the inside of the workpiece, and applying an external force along the streets where strength is lowered due to the formation of these modified layers, to thereby divide the workpiece (see, for example, Japanese Patent No. 3408805).

### SUMMARY OF THE INVENTION

However, for example, a wafer formed with devices such as micro electro mechanical systems (MEMS) has a structure in which a surface of a device area formed with devices is set higher than a surface of a peripheral marginal area surrounding the device area by several tens to several hundreds of micrometers.

In addition, there also exist wafers in which only a back surface side of the device area is ground and an annular projection is formed in the peripheral marginal area surrounding the device area, for reducing the risk of damaging at a time of conveying the wafers after grinding.

In the case of forming modified layers by causing a laser beam to be incident on the inside of the wafer having such a step, it is necessary to process a thick part and a thin part separately, and special software for control such that the laser beam can be turned ON/OFF at freely selected positions is needed.

Accordingly, it is an object of the present invention to provide a workpiece processing method by which processing can be easily applied to the inside of a workpiece having a step.

In accordance with an aspect of the present invention, there is provided a workpiece processing method for processing a workpiece having a step including a higher surface and a lower surface on a side to which a laser beam is applied, by use of a laser processing apparatus that includes a chuck table that holds the workpiece, a laser beam applying unit including a condenser lens that concentrates the laser beam having a transmission wavelength to the workpiece held on the chuck table, and a processing feeding unit that puts the chuck table and the laser beam applying unit into relative processing feeding. The workpiece processing method includes a first processing step of performing processing feeding with a focal point of the condenser lens positioned in the inside of the workpiece spaced by a predetermined distance from the lower surface and processing the inside of an area having the lower surface of the workpiece at a light concentrating point of the laser beam refracted by the lower surface, and a second processing step of performing processing feeding with the focal point of the condenser lens positioned in the inside of the workpiece spaced by a predetermined distance from the higher surface and processing the inside of an area having the higher surface of the workpiece at a light concentrating point of the laser beam refracted by the higher surface. In the first processing step, the light concentrating point formed by refraction of the laser beam by the higher surface is formed outside of the area having the higher surface of the workpiece, so that the area having the higher surface of the workpiece is not processed, and in the second processing step, the focal point of the condenser lens is spaced from the lower surface and is positioned outside of the area having the lower surface of the workpiece, so that the laser beam is diffused and the area having the lower surface of the workpiece is not processed.

According to the present invention, an effect that processing can be easily applied to the inside of a workpiece having a step is produced.

The above and other objects, features and advantages of the present invention and the manner of realizing them will become more apparent, and the invention itself will best be understood from a study of the following description and appended claim with reference to the attached drawings showing some preferred embodiments of the invention.

### BRIEF DESCRIPTION OF THE DRAWINGS

FIG. 1 is a perspective view depicting a configuration example of a laser processing apparatus used in a workpiece processing method according to a first embodiment;

FIG. 2 is a perspective view of a workpiece that is an object to be processed by the workpiece processing method according to the first embodiment;

FIG. 3 is a sectional view of the workpiece depicted in FIG. 2;

FIG. 4 is a flow chart depicting a flow of the workpiece processing method according to the first embodiment;

FIG. 5 is a perspective view depicting a state in which the workpiece is held on a chuck table in a first processing step of the workpiece processing method depicted in FIG. 4;

FIG. 6 is a sectional view schematically depicting a state in which a laser beam is applied in the first processing step of the workpiece processing method depicted in FIG. 4;

FIG. 7 is a sectional view schematically depicting a state in which the laser beam is applied in a second processing step of the workpiece processing method depicted in FIG. 4;

FIG. 8 is a perspective view of a workpiece that is an object to be processed by a workpiece processing method according to a second embodiment;

FIG. 9 is a sectional view of the workpiece depicted in FIG. 8;

FIG. 10 is a sectional view schematically depicting a state in which a laser beam is applied in a first processing step of the workpiece processing method according to the second embodiment; and

FIG. 11 is a sectional view schematically depicting a state in which the laser beam is applied in a second processing step of the workpiece processing method according to the second embodiment.

### DETAILED DESCRIPTION OF THE PREFERRED EMBODIMENTS

Embodiments of the present invention will be described in detail below referring to the drawings. The present invention is not to be limited by contents described in the following embodiments. In addition, components described below include those which can be easily conceived by a person skilled in the art and those which are substantially the same. Further, configurations described below can be combined, as required. Besides, various omissions, replacements, or modifications of the configurations are possible within ranges not departing from the gist of the present invention.

### First Embodiment

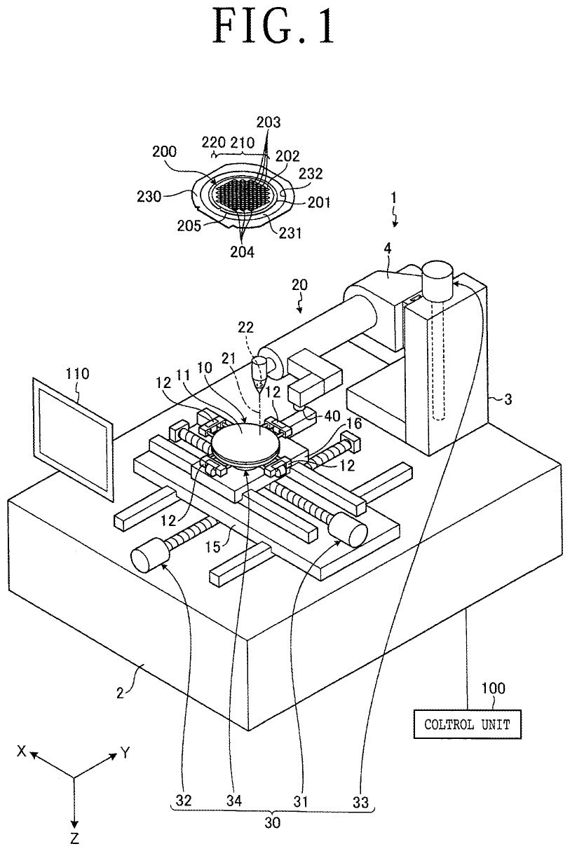

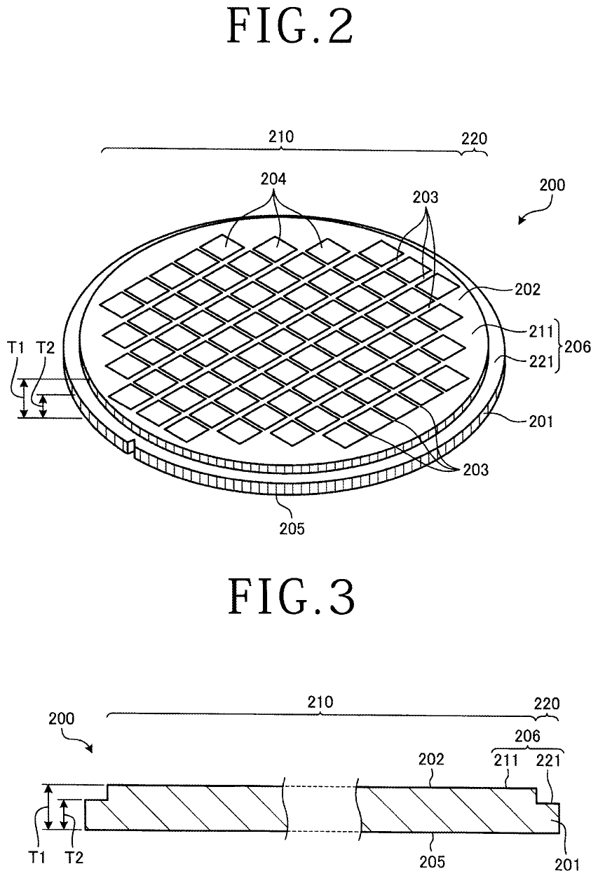

A workpiece processing method according to a first embodiment of the present invention will be described based on the drawings. First, a configuration of a laser processing apparatus 1 used in the workpiece processing method according to the first embodiment will be described. FIG. 1 is a perspective view depicting a configuration example of the laser processing apparatus used in the workpiece processing method according to the first embodiment. FIG. 2 is a perspective view of a workpiece which is an object to be processed by the workpiece processing method according to the first embodiment. FIG. 3 is a sectional view of the workpiece depicted in FIG. 2. The laser processing apparatus 1 depicted in FIG. 1 according to the first embodiment is an apparatus for applying a pulsed laser beam 21 to a workpiece 200 to perform laser processing of the workpiece 200.

### (Workpiece)

The workpiece 200 as an object of processing by the laser processing apparatus 1 depicted in FIG. 1 is a wafer such as a disc-shaped semiconductor wafer or optical device wafer having a substrate 201 of silicon, sapphire, gallium arsenide, or the like. As illustrated in FIG. 1, the workpiece 200 includes a device area 210 and a peripheral marginal area 220 surrounding the device area 210. The device area 210 includes streets 203 set in a grid pattern on a front surface 202 of the substrate 201, and devices 204 formed in respective regions partitioned by the respective streets 203.

The device 204 is, for example, an integrated circuit such as an integrated circuit (IC) or a large scale integration (LSI), an image sensor such as a charge coupled device (CCD) or a complementary metal oxide semiconductor (CMOS), or micro electro mechanical systems (MEMS). The peripheral marginal area 220 surrounds the device area 210 along the whole circumference of the device area 210, and is an area where the devices 204 are not formed on the front surface 202 of the substrate 201. Note that in the first embodiment, the front surface 202 of the substrate 201 is a surface on a side to which a laser beam is applied.

In addition, in the first embodiment, as depicted in FIGS. 2 and 3, a back surface 205 on a back side relative to the front surface 202 of the substrate 201 is formed to be flush over the device area 210 and the peripheral marginal area 220, and a thickness T1 of the device area 210 is set greater than a thickness T2 of the peripheral marginal area 220, so that a step 206 including a front surface 211 of the device area 210 which is a higher surface and a front surface 221 of the peripheral marginal area 220 which is a lower surface is provided on the front surface 202 side. The front surface 211 of the device area 210 and the front surface 221 of the peripheral marginal area 220 are parallel with each other and with the back surface 205 as well.

Note that in the first embodiment, the device area 210 is an area with a large thickness and is an area having the higher surface. The thickness T1 is the thickness of the area having the higher surface. In addition, in the first embodiment, the peripheral marginal area 220 is an area with a smaller thickness, and is an area having the lower surface. The thickness T2 is the thickness of the area having the lower surface. Note that in the first embodiment, the substrate 201 of the workpiece 200 includes silicon, and the devices 204 are MEMS.

Besides, in the first embodiment, the workpiece 200 has an adhesive tape 231 attached to the back surface 205 thereof, the adhesive tape 231 being disc-shaped with a diameter greater than an outside diameter of the workpiece 200 and having an annular frame 230 attached to an outer edge part thereof, and the workpiece 200 is supported in an opening 232 of the annular frame 230 through the adhesive tape 231. In the first embodiment, the workpiece 200 is divided along the streets 203 into individual devices 204.

### (Laser Processing Apparatus)

As illustrated in FIG. 1, the laser processing apparatus 1 includes a chuck table 10 that holds the workpiece 200 on a holding surface 11, a laser beam applying unit 20, a moving unit 30, an imaging unit 40, and a control unit 100.

The chuck table 10 holds the workpiece 200 on the holding surface 11. The holding surface 11 is disc-like in shape formed from a porous ceramic or the like, and is connected to a vacuum suction source not illustrated through a vacuum suction passage not illustrated. The chuck table 10 holds under suction the workpiece 200 placed on the holding surface 11. In the first embodiment, the holding surface 11 is a flat surface parallel to horizontal directions. A plurality of clamp sections 12 for clamping the annular frame 230 supporting the workpiece 200 in the opening 232 are disposed in the periphery of the chuck table 10.

In addition, the chuck table 10 is rotated around an axis parallel to a Z-axis direction orthogonal to the holding surface 11 and parallel to the vertical direction by a rotational moving unit 34 of the moving unit 30. The chuck table 10 is moved in an X-axis direction parallel to a horizontal direction by an X-axis moving unit 31 of the moving unit 30, and is moved in a Y-axis direction parallel to a horizontal direction and orthogonal to the X-axis direction by a Y-axis moving unit 32, together with the rotational moving unit 34.

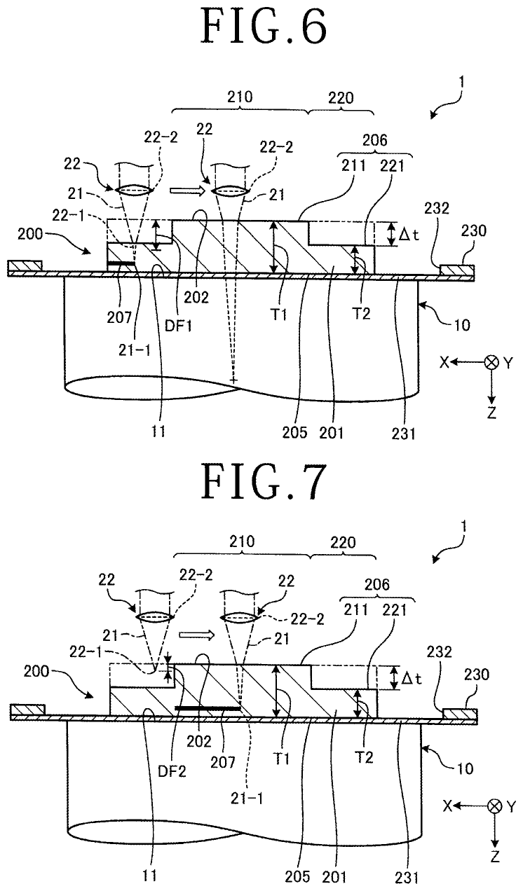

The laser beam applying unit 20 is a unit that applies a pulsed laser beam 21 to the workpiece 200 held on the chuck table 10. In the first embodiment, the laser beam applying unit 20 is laser beam applying means that applies the pulsed laser beam 21 having a transmission wavelength to the workpiece 200, to form modified layers 207 (depicted in FIGS. 6 and 7) which become start point of breaking in the inside of the workpiece 200. The modified layer 207 means a region in which density, refractive index, mechanical strength, or other physical property is different from that of the surroundings. The modified layer 207 is, for example, a melting treatment region, a cracking region, a dielectric breakdown region, a refractive index variation region, or a region where these regions are mixedly present. In the embodiment, the modified layer 207 is lower in mechanical strength than the other parts of the substrate 201.

In the first embodiment, as depicted in FIG. 1, a part of the laser beam applying unit 20 is supported by a lifting member 4 which is moved in the Z-axis direction by a Z-axis moving unit 33 of the moving unit 30 provided on an erecting wall 3 erecting from an apparatus main body 2. The laser beam applying unit 20 includes a laser oscillator that oscillates pulsed laser for processing the workpiece 200, a condenser lens 22 for concentrating the laser beam 21 emitted from the laser oscillator on the workpiece 200 held on the holding surface 11 of the chuck table 10, and at least one optical part which is provided on an optical path of the laser beam 21 between the laser oscillator and the condenser lens 22 and guides the laser beam 21 emitted from the laser oscillator to the condenser lens 22.

The condenser lens 22 is disposed to face the holding surface 11 of the chuck table 10 in the Z-axis direction, transmits the laser beam 21 oscillated from the laser oscillator, and concentrates the laser beam 21 on a light concentrating point 21-1 (depicted in FIGS. 6 and 7). In the first embodiment, the condenser lens 22 is also a convex lens, and has a focal point 22-1 (depicted in FIGS. 6 and 7).

The moving unit 30 relatively moves the laser beam applying unit 20 and the chuck table 10 in the X-axis direction, the Y-axis direction, and the Z-axis direction and around an axis parallel to the Z-axis direction. The X-axis direction and the Y-axis direction are directions parallel to the holding surface 11. The moving unit 30 includes the X-axis moving unit 31 which is a processing feeding unit for moving the chuck table 10 in the X-axis direction, the Y-axis moving unit 32 which is an indexing feeding unit for moving the chuck table 10 in the Y-axis direction, the Z-axis moving unit 33 for moving the condenser lens 22 included in the laser beam applying unit 20 in the Z-axis direction, and the rotational moving unit 34 for rotating the chuck table 10 around the axis parallel to the Z-axis direction.

The Y-axis moving unit 32 is a unit for putting the chuck table 10 and the laser beam applying unit 20 into relative indexing feeding. In the first embodiment, the Y-axis moving unit 32 is disposed on the apparatus main body 2 of the laser processing apparatus 1. The Y-axis moving unit 32 supports a moving plate 15, which supports the X-axis moving unit 31, movably in the Y-axis direction.

The X-axis moving unit 31 is a unit for putting the chuck table 10 and the laser beam applying unit 20 into relative processing feeding. The X-axis moving unit 31 is disposed on the moving plate 15. The X-axis moving unit 31 supports a second moving plate 16, supporting the rotational moving unit 34 which rotates the chuck table 10 around the axis parallel to the Z-axis direction, movably in the X-axis direction. The Z-axis moving unit 33 is disposed on the erecting wall 3, and supports the lifting member 4 movably in the Z-axis direction.

The X-axis moving unit 31, the Y-axis moving unit 32, and the Z-axis moving unit 33 each include a known ball screw provided rotatably around an axis, a known pulse motor that rotates the ball screw around the axis, and known guide rails which support the moving plate 15 or 16 movably in the X-axis direction or the Y-axis direction and support the lifting member 4 movably in the Z-axis direction.

In addition, the laser processing apparatus 1 includes an X-axis direction position detection unit (not illustrated) for detecting a position in the X-axis direction of the chuck table 10, a Y-axis direction position detection unit (not illustrated) for detecting a position in the Y-axis direction of the chuck table 10, and a Z-axis direction position detection unit for detecting a position in the Z-axis direction of the condenser lens 22 included in the laser beam applying unit 20. Each position detection unit outputs a result of detection to a control unit 100.

The imaging unit 40 is for imaging the workpiece 200 held on the chuck table 10. The imaging unit 40 includes an imaging element such as a charge coupled device (CCD) imaging element or a complementary MOS (CMOS) imaging element for imaging the workpiece 200 held on the chuck table 10. In the first embodiment, the imaging unit 40 is attached to a tip of a housing of the laser beam applying unit 20, and is disposed at a position of aligning in the X-axis direction with the condenser lens 22 of the laser beam applying unit 20. The imaging unit 40 images the workpiece 200, to obtain an image for carrying out alignment between the workpiece 200 and the laser beam applying unit 20, and outputs the obtained image to the control unit 100.

The control unit 100 is for controlling the aforementioned components of the laser processing apparatus 1, and causes the laser processing apparatus 1 to perform a processing operation on the workpiece 200. Note that the control unit 100 is a computer including an arithmetic processing device having a microprocessor such as a central processing unit (CPU), a storage device having a memory such as a read only memory (ROM) or a random access memory (RAM), and an input-output interface device. The arithmetic processing device of the control unit 100 performs arithmetic processing according to a computer program stored in the storage device, and outputs control signals for controlling the laser processing apparatus 1 to the aforementioned components of the laser processing apparatus 1 through the input-output interface device, thereby to realize functions of the control unit 100.

In addition, the control unit 100 is connected with a display unit 110 including a liquid crystal display for displaying the state of a processing operation, images, and the like, and an input unit (not illustrated) used when the operator registers processing contents information and the like. The input unit includes at least one of a touch panel provided on the display unit 110 and an external input device such as a keyboard.

### (Workpiece Processing Method)

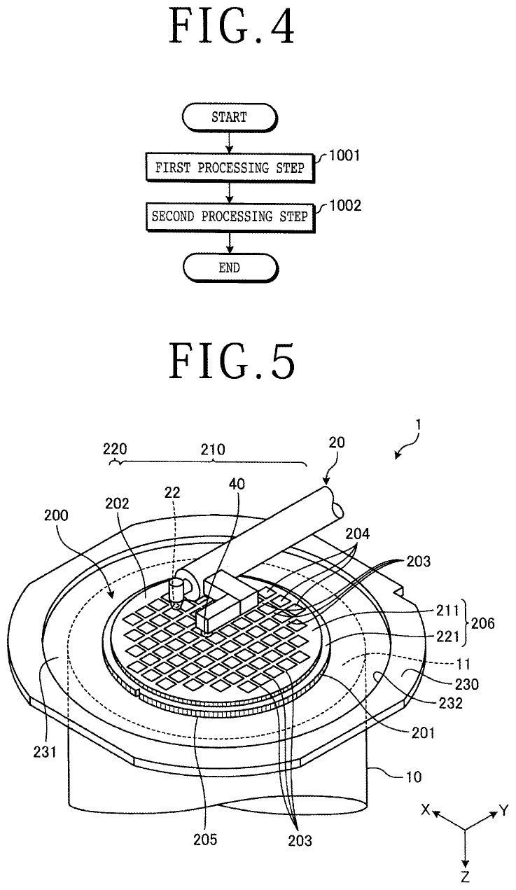

Next, the workpiece processing method will be described. The workpiece processing method is a method for laser processing of the workpiece 200 by use of the aforementioned laser processing apparatus 1, to form along the streets 203 the modified layers 207 which become start points of breaking in the inside of the workpiece 200. FIG. 4 is a flow chart depicting the flow of the workpiece processing method according to the first embodiment. As depicted in FIG. 4, the workpiece processing method includes a first processing step 1001 and a second processing step 1002. Each step of the workpiece processing method will be described below.

### (First Processing Step)

FIG. 5 is a perspective view depicting a state in which the workpiece is held on the chuck table in the first processing step of the workpiece processing method depicted in FIG. 4. FIG. 6 is a sectional view schematically depicting a state in which a laser beam is applied in the first processing step of the workpiece processing method depicted in FIG. 4.

The first processing step 1001 is a step of performing processing feeding of the chuck table 10 with the focal point 22-1 of the condenser lens 22 positioned in the inside of the workpiece 200 spaced by a predetermined distance from the front surface 221 of the peripheral marginal area 220 which is the lower surface of the workpiece 200, to perform processing for forming the modified layers 207 in the inside of the peripheral marginal area 220 of the workpiece 200 at the light concentrating point 21-1 of the laser beam 21 refracted by the front surface 221.

In the first embodiment, in the first processing step 1001, the processing contents information inputted by an operator's operation of the input unit or the like is accepted by the control unit 100, the workpiece 200 is placed on the holding surface 11 of the chuck table 10 through the adhesive tape 231, and, when the control unit 100 accepts an operator's processing operation starting instruction from the input unit, the laser processing apparatus 1 starts a processing operation based on the processing contents information registered.

In the first processing step 1001, as depicted in FIG. 5, the laser processing apparatus 1 holds under suction the workpiece 200 on the holding surface 11 of the chuck table 10 through the adhesive tape 231, and the annular frame 230 is clamped by the clamp sections 12. Note that FIG. 5 omits the clamp sections 12.

Next, in the first processing step 1001, the moving unit 30 of the laser processing apparatus 1 moves the chuck table 10 toward a lower side of the imaging unit 40, and the imaging unit 40 images the workpiece 200. In the first processing step 1001, the laser processing apparatus 1 performs alignment, based on the image obtained by imaging by the imaging unit 40.

In the first processing step 1001, based on the processing contents information, the laser processing apparatus 1 applies a pulsed laser beam 21 from the laser beam applying unit 20 to the street 203, while relatively moving the laser beam applying unit 20 and the workpiece 200 along the street 203 by processing feeding of the chuck table 10. In the first embodiment, in the first processing step 1001, as depicted in FIG. 6, the laser processing apparatus 1 positions the height of the focal point 22-1 of the condenser lens 22 in the inside of the substrate 201 of the peripheral marginal area 220. In other words, the processing apparatus 1 positions the height of the focal point 22-1 of the condenser lens 22 below the front surface 221 of the peripheral marginal area 220 and above the back surface 205, positions the focal point 22-1 of the condenser lens 22 in the inside of the workpiece 200 spaced by a predetermined distance from the front surface 221 of the peripheral marginal area 220, and the chuck table 10 is put into processing feeding.

In addition, in the first processing step 1001, let a position where a distance in the Z-axis direction between a main surface 22-2 (indicated by a broken line in FIG. 6) of the condenser lens 22 and the front surface 211 of the device area 210 which is the higher surface is equal to the focal distance of the condenser lens 22 be a just focus (JF) position, let a deviation amount (which is a distance in the Z-axis direction) of the light concentrating point 21-1 from the JF position (namely, the front surface 211 of the device area 210 which is the higher surface) in a case where the condenser lens 22 is moved from the JF position be DF1, let a distance in the Z-axis direction between the front surface 211 of the device area 210 and the front surface 221 of the peripheral marginal area 220 be Δt, and let a refractive index of the substrate 201 of the workpiece 200 be r, then the laser processing apparatus 1 positions the position in the Z-axis direction of the condenser lens 22 at such a position as to satisfy both the following expression 1 and expression 2, and applies the pulsed laser beam 21 from the laser beam applying unit 20 to the street 203.

DF1>Δt Expression 1

(DF1−Δt)×r≤T2 Expression 2

Therefore, in the first processing step 1001, as depicted in FIG. 6, the focal point 22-1 of the condenser lens 22 is positioned in the peripheral marginal area 220, and the laser beam 21 refracted at the front surface 221 of the peripheral marginal area 220 and entering the substrate 201 of the workpiece 200 is concentrated at the light concentrating point 21-1 inside the substrate 201 of the peripheral marginal area 220, whereby processing to form the modified layer 207 in the inside of the peripheral marginal area 220 of the workpiece 200 is performed. In addition, in the first processing step 1001, the light concentrating point 21-1 of the laser beam 21 formed by refraction at the front surface 211 of the device area 210 and entering the substrate 201 of the workpiece 200 is formed on the outside of the device area 210 while being positioned on the lower side than the back surface 205 of the device area 210 of the workpiece 200, so that the device area 210 of the workpiece 200 is not processed, and the modified layer 207 is not formed.

In this way, in the first processing step 1001, the laser processing apparatus 1 sets the light concentrating point 21-1 of the laser beam 21 in the inside of the substrate 201 of only the peripheral marginal area 220 of the workpiece 200, and the modified layer 207 is formed along the street 203 in the inside of the substrate 201 of only the peripheral marginal area 220. In other words, in the first processing step 1001, the laser processing apparatus 1 forms the modified layer 207 along the street 203 in the inside of only the peripheral marginal area 220 out of the device area 210 and the peripheral marginal area 220. In the first processing step 1001, when the laser processing apparatus 1 has formed the modified layers 207 along all the streets 203 in the inside of only the substrate 201 of the peripheral marginal area 220, the application of the laser beam 21 is stopped.

Thus, the first processing step 1001 is a step of processing the workpiece 200 by positioning the condenser lens 22 at such a height as to process only the peripheral marginal area 220 out of the device area 210 and the peripheral marginal area 220. Note that in the present invention, in the first processing step 1001, while relatively moving the laser beam applying unit 20 and the workpiece 200 along the street 203, the pulsed laser beam 21 is applied at least once from the laser beam applying unit 20 to all the streets 203. In other words, in the present invention, in the first processing step 1001, the laser beam applying unit 20 is moved at least one pass relative to the workpiece 200 along each street 203, thereby applying the laser beam 21. Note that in the present invention, in the first processing step 1001, in each pass, a position in the Z-axis direction of the light concentrating point 21-1 may be or may not be changed; in a case where the position is changed, it is desirable to change the position in the Z-axis direction of the light concentrating point 21-1 sequentially from the lower side toward the upper side.

### (Second Processing Step)

FIG. 7 is a sectional view schematically depicting a state in which the laser beam is applied in a second processing step of the workpiece processing method depicted in FIG. 4. The second processing step 1002 is a step of performing processing feeding of the chuck table 10 while positioning the focal point 22-1 of the condenser lens 22 in the inside of the workpiece 200 spaced by a predetermined distance from the front surface 211 of the device area 210 which is the higher surface of the workpiece 200, and processing to form the modified layer 207 in the inside of the device area 210 of the workpiece 200 at the light concentrating point 21-1 of the laser beam 21 refracted at the front surface 211.

In the second processing step 1002, based on the processing contents information, the laser processing apparatus 1 applies the pulsed laser beam 21 from the laser beam applying unit 20 to the street 203, while putting the chuck table 10 into processing feeding and while relatively moving the laser beam applying unit 20 and the workpiece 200 along the street 203 by the X-axis moving unit 31 of the moving unit 30. In the first embodiment, in the second processing step 1002, as depicted in FIG. 7, the laser processing apparatus 1 positions the height of the focal point 22-1 of the condenser lens 22 inside the substrate 201 in the device area 210 and outside the substrate 201 in the peripheral marginal area 220. In other words, the laser processing apparatus 1 puts the chuck table 10 into processing feeding, while positioning the height of the focal point 22-1 of the condenser lens 22 below the front surface 211 of the device area 210 and above the front surface 221 of the peripheral marginal area 220 and then positioning the focal point 22-1 of the condenser lens 22 in the inside of the workpiece 200 spaced by a predetermined distance from the front surface 211 of the device area 210.

In addition, in the second processing step 1002, let a position where the distance in the Z-axis direction between the main surface 22-2 of the condenser lens 22 and the front surface 211 of the device area 210 which is the higher surface is equal to the focal distance of the condenser lens 22 be the just focus (JF) position, and let the deviation amount (which is the distance in the Z-axis direction) of the light concentrating point 21-1 from the JF position in a case where the condenser lens 22 is moved from the JF position be DF2, then the laser processing apparatus 1 applies the pulsed laser beam 21 from the laser beam applying unit 20 to the street 203, by positioning the position in the Z-axis direction of the condenser lens 22 at such a position as to satisfy both of the following expression 3 and expression 4.

DF2<Δt Expression 3

DF2×r≤T1 Expression 4

Therefore, in the second processing step 1002, as depicted in FIG. 7, the focal point 22-1 of the condenser lens 22 is positioned (spaced) closer to the laser beam applying unit 20 side than (from) the front surface 221 of the peripheral marginal area 220 which is the lower surface. In the second processing step 1002, the focal point 22-1 of the condenser lens 22 is positioned closer to the laser beam applying unit 20 side than the peripheral marginal area 220 of the workpiece 200, whereby the laser beam 21 is diffused, and the peripheral marginal area 220 of the workpiece 200 is not processed, so that the modified layer 207 is not formed in the inside of the peripheral marginal area 220. In addition, in the second processing step 1002, as depicted in FIG. 7, the focal point 22-1 of the condenser lens 22 is positioned in the inside of the device area 210, and the laser beam 21 refracted at the front surface 211 of the device area 210 and entering the substrate 201 of the workpiece 200 is concentrated at the light concentrating point 21-1 inside of the substrate 201 of the device area 210, whereby processing to form the modified layer 207 in the inside of the device area 210 of the workpiece 200 is performed.

Thus, in the second processing step 1002, the laser processing apparatus 1 sets the light concentrating point 21-1 of the laser beam 21 in the inside of the substrate 201 in only the device area 210 of the workpiece 200, and forms the modified layer 207 along the street 203 in the inside of the substrate 201 in only the device area 210. In other words, in the second processing step 1002, the laser processing apparatus 1 forms the modified layer 207 along the street 203 in the inside of only the device area 210 out of the device area 210 and the peripheral marginal area 220.

Thus, the second processing step 1002 is a step of processing the workpiece 200 by positioning the condenser lens 22 at such a height that only the device area 210 out of the device area 210 and the peripheral marginal area 220 is processed. In addition, in the first embodiment, in the first processing step 1001 and the second processing step 1002, the modified layers 207 are formed at positions where the positions in the Z-axis direction are the same. Note that in the present invention, in the second processing step 1002, while relatively moving the laser beam applying unit 20 and the workpiece 200 along the street 203, the pulsed laser beam 21 is applied at least once from the laser beam applying unit 20 to all the streets 203. In other words, in the present invention, in the second processing step 1002, the laser beam 21 is applied by moving the laser beam applying unit 20 by at least one pass along each street 203 relative to the workpiece 200. Note that in the present invention, in the second processing step 1002, the position in the Z-axis direction of the light concentrating point 21-1 may be or may not be changed in each pass; in a case where the position is changed, it is desirable to position the position in the Z-axis direction of the light concentrating point 21-1 sequentially from the lower side toward the upper side. In addition, FIG. 7 omits the modified layers 207 formed in the first processing step 1001.

In the second processing step 1002, when the laser processing apparatus 1 has formed the modified layers 207 along all the streets 203 in the inside of only the substrate 201 in the device area 210, the application of the laser beam 21 is stopped. In the second processing step 1002, when the laser processing apparatus 1 stops suction holding of the workpiece 200 by the chuck table 10 and the clamping of the annular frame 230 by the clamp sections 12 is released, the processing operation, namely, the workpiece processing method is finished. The workpiece 200 is broken with the modified layers 207 as start points of breaking, by extension of the adhesive tape 231 or the like, to be divided into individual devices 204.

In this way, in the workpiece processing method according to the first embodiment, in the first processing step 1001 and the second processing step 1002, with the aforementioned expression 1, expression 2, expression 3, and expression 4 satisfied, in consideration of the thicknesses T1 and T2 of the workpiece 200, the distance Δt in the Z-axis direction between the front surface 211 of the device area 210 and the front surface 221 of the peripheral marginal area 220, and the refractive index r of the substrate 201 of the workpiece 200, the height of the condenser lens 22 is set so as to form the modified layers 207 only in the inside of the peripheral marginal area 220 in the first processing step 1001 and to form the modified layers 207 only in the inside of the device area 210 in the second processing step 1002.

As has been described above, the workpiece processing method according to the first embodiment includes the first processing step 1001 of processing the workpiece 200 by positioning the condenser lens 22 at such a height that only the peripheral marginal area 220 is processed, and the second processing step 1002 of processing the workpiece 200 by positioning the condenser lens 22 at such a height that only the device area 210 is processed. In addition, the workpiece processing method according to the first embodiment satisfies the expression 1 and the expression 2 in the first processing step 1001, and satisfies the expression 3 and the expression 4 in the second processing step 1002, whereby the height of the condenser lens 22 is set at such a height as to form the modified layers 207 only in the inside of the peripheral marginal area 220 in the first processing step 1001, and to form the modified layers 207 only in the inside of the device area 210 in the second processing step 1002.

Therefore, the workpiece processing method according to the first embodiment can form the modified layers 207 in the inside of the substrate 201 of the workpiece 200 having the step 206, by repeating application of the pulsed laser beam 21 over the peripheral marginal area 220 and the device area 210, without performing ON/OFF control of the laser beam by use of special software, in both the first processing step 1001 and the second processing step 1002. As a result, the workpiece processing method according to the first embodiment produces an effect that processing to form the modified layers 207 in the inside of the substrate 201 of the workpiece 200 having the step 206 can be easily performed.

### Second Embodiment

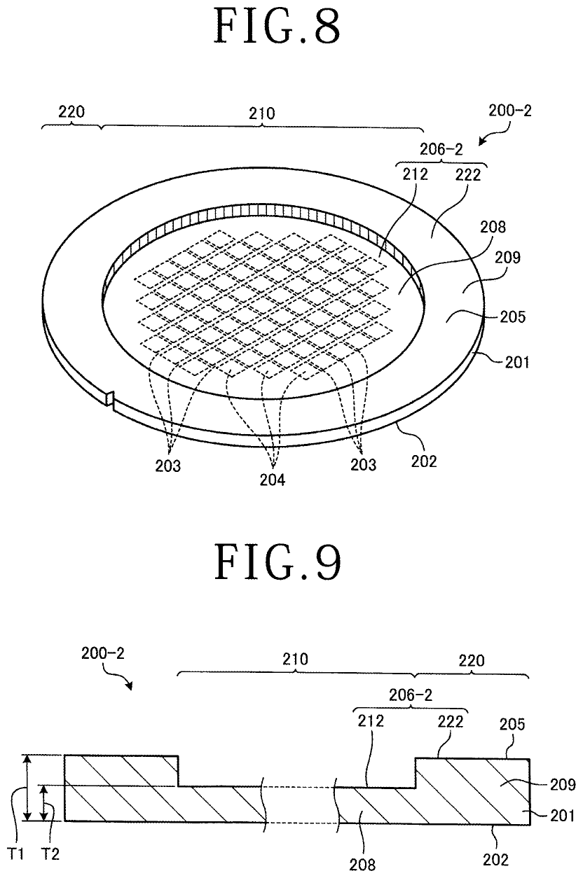

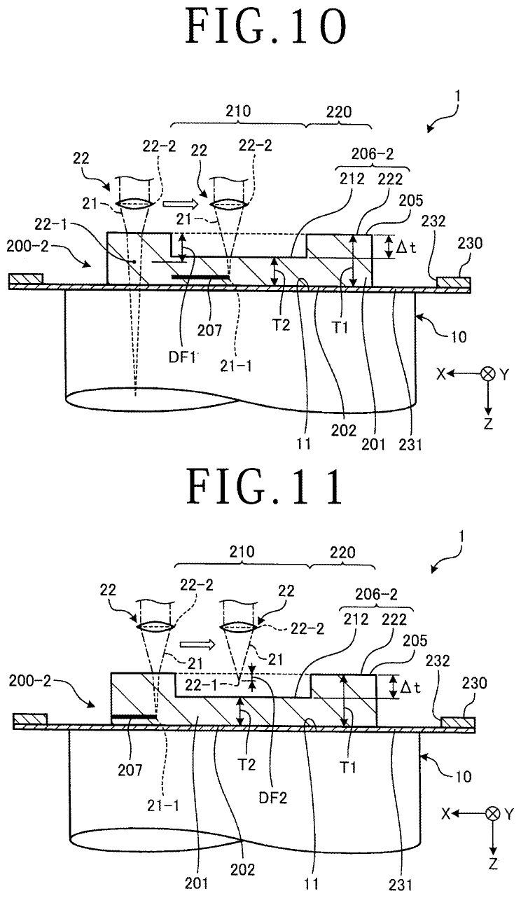

A workpiece processing method according to a second embodiment of the present invention will be described based on the drawings. FIG. 8 is a perspective view of a workpiece as an object to be processed by the workpiece processing method according to the second embodiment. FIG. 9 is a sectional view of the workpiece depicted in FIG. 8. FIG. 10 is a sectional view schematically depicting a state in which a laser beam is applied in a first processing step of the workpiece processing method according to the second embodiment. FIG. 11 is a sectional view schematically depicting a state in which a laser beam is applied in a second processing step of the workpiece processing method according to the second embodiment. Note that in the description of the second embodiment, the parts in FIGS. 8, 9, 10 and 11 which are the same as those in the first embodiment are denoted by the same reference symbols as used above and descriptions thereof will be omitted.

A workpiece 200-2 as an object to be processed by the workpiece processing method according to the second embodiment has a back surface 205 of a substrate 201 as a surface on the side where a laser beam 21 is applied. The workpiece 200-2 as the object to be processed by the workpiece processing method according to the second embodiment is a generally-called TAIKO (registered trademark) wafer in which the back surface 205 of a device area 210 is ground, as depicted in FIGS. 8 and 9, a circular recess 208 is formed on the back surface 205 side in the device area 210, and an annular projection 209 where a peripheral marginal area 220 is thicker than the device area 210 is formed. Therefore, in the second embodiment, the workpiece 200-2 has, on the back surface 205 side, a step 206-2 including a back surface 222 of the peripheral marginal area 220 which is a higher surface and a back surface 212 of the device area 210 which is a lower surface.

Note that in the second embodiment, the device area 210 is an area with a small thickness, and an area having the lower surface. The thickness T2 of the device area 210 is the thickness of the area having the lower surface. In addition, in the second embodiment, the peripheral marginal area 220 is an area with a large thickness, and the area having the higher surface. The thickness T1 of the peripheral marginal area 220 is the thickness of the area having the higher surface.

Besides, in the second embodiment, the workpiece 200-2 has an adhesive tape 231 attached on the front surface 202 thereof, the adhesive tape 231 being disc-like in shape having a diameter larger than an outside diameter of the workpiece 200-2 and having an annular frame 230 attached to a peripheral edge part thereof, and the workpiece 200-2 is supported in an opening 232 of the annular frame 230 through the adhesive tape 231. In the second embodiment, the workpiece 200-2 has its front surface 202 side held under suction on a holding surface 11 of a chuck table 10 through the adhesive tape 231.

Like the first embodiment, the workpiece processing method according to the second embodiment includes a first processing step 1001 and a second processing step 1002. The first processing step 1001 of the workpiece processing method according to the second embodiment is a step of putting the chuck table 10 into processing feeding while positioning the focal point 22-1 of a condenser lens 22 in the inside of the workpiece 200 spaced by a predetermined distance from the back surface 212 of the device area 210 which is the lower surface of the workpiece 200-2, and processing to form a modified layer 207 in the inside of the device area 210 of the workpiece 200-2 at a light concentrating point 21-1 of a laser beam 21 refracted at the back surface 212.

In the second embodiment, in the first processing step 1001, as depicted in FIG. 10, a laser processing apparatus 1 positions the height of the focal point 22-1 of the condenser lens 22 inside the substrate 201 of the device area 210. In other words, the laser processing apparatus 1 puts the chuck table 10 into processing feeding while positioning the height of the focal point 22-1 of the condenser lens 22 below the back surface 212 of the device area 210 and above the front surface 202, and positioning the focal point 22-1 of the condenser lens 22 in the inside of the workpiece 200 spaced by a predetermined distance from the back surface 212 of the device area 210.

In addition, in the second embodiment, in the first processing step 1001, let a position where the distance in the Z-axis direction between a main surface 22-2 of the condenser lens 22 and the back surface 222 of the peripheral marginal area 220 which is the higher surface is equal to the focal distance of the condenser lens 22 be a just focus (JF) position, let the deviation amount (which is a distance in the Z-axis direction) of the light concentrating point 21-1 from the JF position (namely, the back surface 222 of the peripheral marginal area 220 which is the higher surface) in a case where the condenser lens 22 is moved from the JF position be DF1, let the distance in the Z-axis direction between the back surface 222 of the peripheral marginal area 220 and the back surface 212 of the device area 210 be Δt, and let the refractive index of the substrate 201 of the workpiece 200 be r, then a pulsed laser beam 21 is applied from a laser beam applying unit 20 to a street 203, while positioning the position in the Z-axis direction of the condenser lens 22 at such a position as to satisfy both the aforementioned expression 1 and expression 2, like in the first embodiment.

Therefore, in the second embodiment, in the first processing step 1001, as depicted in FIG. 10, a light concentrating point 21-1 of a laser beam 21 refracted at the back surface 222 of the peripheral marginal area 220 and entering the substrate 201 of the workpiece 200 is positioned on the lower side than the front surface 202 of the peripheral marginal area 220 of the workpiece 200 and is formed outside the peripheral marginal area 220, so that the peripheral marginal area 220 of the workpiece 200 is not processed, and a modified layer 207 is not formed therein.

Besides, in the second embodiment, in the first processing step 1001, as depicted in FIG. 10, the focal point 22-1 of the condenser lens 22 is positioned inside the device area 210, and the laser beam 21 refracted at the back surface 212 of the device area 210 and entering the substrate 201 of the workpiece 200 is concentrated on the light concentrating point 21-1 in the inside of the substrate 201 of the device area 210, whereby processing to form the modified layer 207 in the inside of the device area 210 of the workpiece 200 is performed.

Thus, in the second embodiment, in the first processing step 1001, the laser processing apparatus 1 sets the light concentrating point 21-1 of the laser beam 21 in the inside of the substrate 201 of only the device area 210 of the workpiece 200-2, and forms the modified layer 207 along the street 203 in the inside of the substrate 201 in only the device area 210. In other words, in the second embodiment, in the first processing step 1001, the laser processing apparatus 1 forms the modified layer 207 along the street 203 in the inside of only the device area 210 out of the device area 210 and the peripheral marginal area 220.

Thus, in the second embodiment, the first processing step 1001 is a step of processing the workpiece 200 by positioning the condenser lens 22 at such a height that only the device area 210 out of the device area 210 and the peripheral marginal area 220 is processed.

A second processing step 1002 of the workpiece processing method according to the second embodiment is a step of putting the chuck table 10 into processing feeding while positioning the focal point 22-1 of the condenser lens 22 in the inside of the workpiece 200 spaced by a predetermined distance from the back surface 222 of the peripheral marginal area 220 which is the higher surface of the workpiece 200-2, and processing to form the modified layer 207 in the inside of the peripheral marginal area 220 of the workpiece 200-2 at the light concentrating point 21-1 of the laser beam 21 refracted at the back surface 222.

In the second embodiment, in the second processing step 1002, as depicted in FIG. 11, the laser processing apparatus 1 positions the height of the focal point 22-1 of the condenser lens 22 inside the substrate 201 of the peripheral marginal area 220 and outside the substrate 201 of the device area 210. In other words, the laser processing apparatus 1 puts the chuck table 10 into processing feeding while positioning the height of the focal point 22-1 of the condenser lens 22 below the back surface 222 of the peripheral marginal area 220 and above the back surface 212 of the device area 210, and positioning the focal point 22-1 of the condenser lens 22 in the inside of the workpiece 200-2 spaced by a predetermined distance from the back surface 222 of the peripheral marginal area 220.

In addition, in the second embodiment, in the second processing step 1002, let a position where the distance in the Z-axis direction between the main surface 22-2 of the condenser lens 22 and the back surface 222 of the peripheral marginal area 220 which is the higher surface is equal to the focal distance of the condenser lens 22 be the just focus (JF) position, and let the deviation amount (which is the distance in the Z-axis direction) of the light concentrating point 21-1 from the JF position in the case where the condenser lens 22 is moved from the JF position be DF2, then the pulsed laser beam 21 is applied from the laser beam applying unit 20 to the street 203, while positioning the position in the Z-axis direction of the condenser lens 22 at such a position as to satisfy both the aforementioned expression 3 and expression 4, like in the first embodiment.

Therefore, in the second embodiment, in the second processing step 1002, as depicted in FIG. 11, the focal point 22-1 of the condenser lens 22 is positioned in the inside of the peripheral marginal area 220, and the laser beam 21 refracted at the back surface 222 of the peripheral marginal area 220 and entering the substrate 201 of the workpiece 200 is concentrated on the light concentrating point 21-1 in the inside of the substrate 201 of the peripheral marginal area 220, whereby processing to form the modified layer 207 in the inside of the peripheral marginal area 220 of the workpiece 200 is performed.

Besides, in the second embodiment, in the second processing step 1002, as depicted in FIG. 11, the focal point 22-1 of the condenser lens 22 is positioned (spaced) closer to the laser beam applying unit 20 side than (from) the back surface 212 of the device area 210 which is the lower surface. In the second embodiment, in the second processing step 1002, the focal point 22-1 of the condenser lens 22 is positioned closer to the laser beam applying unit 20 side than the device area 210 of the workpiece 200, whereby the laser beam 21 is diffused, and the device area 210 of the workpiece 200 is not processed, so that the modified layer 207 is not formed in the inside of the device area 210.

Thus, in the second embodiment, in the second processing step 1002, the laser processing apparatus 14 sets the light concentrating point 21-1 of the laser beam 21 in the inside of the substrate 201 of only the peripheral marginal area 220 of the workpiece 200-2, and forms the modified layer 207 along the street 203 in the inside of the substrate 201 of only the peripheral marginal area 220. In other words, in the second embodiment, in the second processing step 1002, the laser processing apparatus 1 forms the modified layer 207 along the street 203 in the inside of only the peripheral marginal area 220 out of the device area 210 and the peripheral marginal area 220. In this way, in the second embodiment, the second processing step 1002 is a step of processing the workpiece 200-2 while positioning the condenser lens 22 at such a height that only the peripheral marginal area 220 out of the device area 210 and the peripheral marginal area 220 is processed.

In addition, in the second embodiment, in the first processing step 1001 and the second processing step 1002, the modified layers 207 are formed at positions where the positions in the Z-axis direction are the same. Besides, in the present invention, also in the second embodiment, in the first processing step 1001 and the second processing step 1002, the laser beam 21 is applied while moving the laser beam applying unit 20 at least by one pass along each street 203 relative to the workpiece 200. In the present invention, also in the second embodiment, in the first processing step 1001 and the second processing step 1002, the position in the Z-axis direction of the light concentrating point 21-1 may be or may not be changed for each pass; in the case where the position is changed, it is desirable to position the position in the Z-axis direction of the light concentrating point 21-1 sequentially from the lower side toward the upper side. In addition, FIG. 11 omits the modified layers 207 formed in the first processing step 1001.

Besides, the workpiece processing method according to the second embodiment, in the first processing step 1001 and the second processing step 1002, with the aforementioned expression 1, expression 2, expression 3, and expression 4 satisfied, in consideration of the thicknesses T1 and T2 of the workpiece 200-2, the distance Δt in the Z-axis direction between the back surface 222 of the peripheral marginal area 220 and the back surface 212 of the device area 210, and the refractive index r of the substrate 201 of the workpiece 200, the height of the condenser lens 22 is set so as to form the modified layers 207 only in the inside of the device area 210 in the first processing step 1001 and to form the modified layers 207 only in the inside of the peripheral marginal area 220 in the second processing step 1002.

The workpiece processing method according to the second embodiment includes the first processing step 1001 of processing the workpiece 200 while positioning the condenser lens 22 at such a height that only the device area 210 is processed and the second processing step 1002 of processing the workpiece 200 while positioning the condenser lens 22 at such a height that only the peripheral marginal area 220 is processed. In addition, the workpiece processing method according to the second embodiment satisfies the expression 1 and the expression 2 in the first processing step 1001, and satisfies the expression 3 and the expression 4 in the second processing step 1002, whereby the height of the condenser lens 22 is set at such a height that the modified layers 207 are formed only in the inside of the device area 210 in the first processing step and that the modified layers 207 are formed only in the inside of the peripheral marginal area 220 in the second processing step 1002.

Therefore, the workpiece processing method according to the second embodiment can form the modified layers 207 in the inside of the substrate 201 of the workpiece 200-2 having the step 206-2, by repeating the application of the pulsed laser beam 21 over the peripheral marginal area 220 and the device area 210, without performing ON/OFF control of the laser beam by use of special software, both in the first processing step 1001 and in the second processing step 1002. As a result, the workpiece processing method according to the second embodiment produces an effect that processing to form the modified layers 207 in the inside of the substrate 201 of the workpiece 200-2 having the step 206-2 can be easily performed, like in the first embodiment.

### First Example

A workpiece processing method according to a first example will be described. In the first example, a disc-shaped workpiece 200-2 having a thickness T1 of 200 μm, a thickness T2 of 100 μm, a distance Δt of 100 μm, a substrate 201 formed of silicon (namely, a refractive index of approximately 4), an outside diameter of six inches, a width of each street 203 of 200 μm, and a device 204 of 7 mm×3.7 mm has been subjected to the workpiece processing method according to the second embodiment, by performing the first processing step 1001 with DF1 sequentially set to −120 μm and −110 μpm and performing the second processing step 1002 with DF2 sequentially set to −44 μm, −31 μm, and −10 μm. In the first example, formation of the modified layers 207 has been achieved only in the device area 210 in the first processing step 1001, and formation of the modified layers 207 has been achieved only in the inside of the peripheral marginal area 220 in the second processing step 1002.

Note that the present invention is not limited to the above-described embodiments. In other words, the present invention can be carried out with various modifications in such ranges as not to depart from the gist of the invention. Note that in the present invention, the order in which the first processing step 1001 and the second processing step 1002 are carried out is not limited to the one described in the embodiments, insofar as the modified layers 207 necessary for processing can be formed.

The present invention is not limited to the details of the above described preferred embodiments. The scope of the invention is defined by the appended claim and all changes and modifications as fall within the equivalence of the scope of the claim are therefore to be embraced by the invention.

What is claimed is:

1. A workpiece processing method for processing a workpiece having a step including a higher surface and a lower surface on a side to which a laser beam is applied, by use of a laser processing apparatus that includes a chuck table that holds the workpiece, a laser beam applying unit including a condenser lens that concentrates the laser beam having a transmission wavelength to the workpiece held on the chuck table, and a processing feeding unit that puts the chuck table and the laser beam applying unit into relative processing feeding, the workpiece processing method comprising:
a first processing step of performing processing feeding with a focal point of the condenser lens positioned in the inside of the workpiece spaced by a predetermined distance from the lower surface and processing the inside of an area having the lower surface of the workpiece at a light concentrating point of the laser beam refracted by the lower surface; and
a second processing step of performing processing feeding with the focal point of the condenser lens positioned in the inside of the workpiece spaced by a predetermined distance from the higher surface and processing the inside of an area having the higher surface of the workpiece at a light concentrating point of the laser beam refracted by the higher surface,
wherein, in the first processing step, the light concentrating point formed by refraction of the laser beam by the higher surface is formed outside of the area having the higher surface of the workpiece, so that the area having the higher surface of the workpiece is not processed, and
in the second processing step, the focal point of the condenser lens is spaced from the lower surface and is positioned outside of the area having the lower surface of the workpiece, so that the laser beam is diffused and the area having the lower surface of the workpiece is not processed.
